(19) United States
(12) Patent Application Publication
(10) Pub. No.: US 2025/0121325 A1
(43) Pub. Date: Apr. 17, 2025

(54) ELECTROCHEMICAL CAPTURE OF CARBON DIOXIDE FROM AIR WITH ELECTRICITY STORAGE

(71) Applicant: The Johns Hopkins University, Baltimore, MD (US)

(72) Inventors: Hao SHEN, Baltimore, MD (US); Chao WANG, Baltimore, MD (US); Yuxuan WANG, Baltimore, MD (US); Guangye ZHOU, Baltimore, MD (US)

(21) Appl. No.: 18/686,501

(22) PCT Filed: Sep. 19, 2022
(86) PCT No.: PCT/US2022/076642

§ 371 Date: Feb. 26, 2024

Related U.S. Application Data
(60) Provisional application No. 63/245,538, filed on Sep. 17, 2021.

(51) Int. Cl. B01D 53/78; B01D 53/62; B01D 53/96; C25B 1/26; C25B 15/08

(52) U.S. Cl. CPC B01D 53/78; B01D 53/62; B01D 53/965; C25B 1/26; C25B 15/083; B01D 2251/108; B01D 2251/304; B01D 2257/504; B01D 2258/0283; B01D 2258/06

(57) ABSTRACT

Electrochemistry-based systems and methods for capturing carbon dioxide from ambient air and other carbon dioxide sources are disclosed.

### FIELD OF THE INVENTION

The present disclosure relates to an electrochemical system for capturing carbon dioxide from the atmosphere and other carbon dioxide sources and the simultaneous storage of electrical storage.

### BACKGROUND

Carbon dioxide (CO₂) capture, utilization, and storage (CCUS) is a promising solution to the global challenges related to the excessive emission of CO₂. Strategies for capturing CO₂, including the direct air capture (DAC) of low concentration CO₂ from the atmosphere and the capture of higher concentrations of CO₂ from emissions from industrial manufacturing and agricultural sources, are important for addressing these challenges. Although DAC is a promising solution to the global challenges associated with the excessive emission of CO₂, significant technical barriers exist for the efficient extraction of ultra-dilute (approximately 400 ppm) CO₂ from the ambient atmosphere, e.g., air, and other CO₂ sources.

### SUMMARY

In some aspects, the presently disclosed subject matter provides a system for capturing CO₂ comprising:
(a) a first membrane reactor comprising an ion-exchange membrane operationally positioned between an anode chamber and a cathode chamber, wherein the anode chamber comprises an inlet in fluid communication with a brine source and an outlet for Cl₂/H₂O and wherein the cathode chamber has a water inlet and an outlet for H₂ and caustic soda;
(b) a gas-liquid separator comprising an inlet in fluid communication with the outlet for H₂ and caustic soda of the cathode chamber of the first membrane reactor and a first outlet for H₂ and a second outlet for NaOH;
(c) a CO₂ absorption reactor, wherein the CO₂ absorption reactor has an inlet for introducing CO₂ from a CO₂ source, an inlet for caustic soda in fluid communication with the gas liquid separator, and an outlet for NaHCO₃/Na₂CO₃;
(d) a second membrane reactor comprising an ion-exchange membrane operationally positioned between an anode chamber and a cathode chamber, wherein the anode chamber has an inlet for Cl₂ in fluid communication the outlet of the anode chamber of the first membrane reactor and an outlet for HCl and wherein the cathode chamber has an inlet in fluid communication with the H₂ outlet of the gas-liquid separator and an aqueous NaOH solution outlet; and
(e) an acid-base reactor comprising a first inlet in fluid communication with the HCl outlet of the anode chamber of the second membrane reactor and a second inlet in fluid communication with the NaHCO₃/Na₂CO₃ outlet of the CO₂ absorption reactor and a first outlet in fluid communication with the brine source and a second outlet for releasing CO₂;
wherein the second membrane reactor is configured to produce an electricity output and is in electrical communication with the first membrane reactor.

In some aspects, the ion exchange membrane of the first membrane reactor and/or the ion exchange membrane of the second membrane reactor comprises a cation exchange membrane or a proton exchange membrane.

In some aspects, the ion exchange membrane of the first membrane reactor and/or the ion exchange membrane of the second membrane reactor comprises an anion exchange membrane or a hydroxyl exchange membrane.

In some aspects, the CO₂ absorption reactor further comprises a water trap.

In other aspects, the presently disclosed subject matter provides a method for capturing CO₂ from a CO₂ source comprising:
(a) providing system for capturing CO₂ described immediately hereinabove;
(b) introducing brine into the anode chamber of the first membrane reactor, thereby electrolyzing the brine and producing chlorine gas and electrolyte-containing chlorine gas in the anode chamber and hydrogen gas and caustic soda in the cathode chamber;
(c) separating the hydrogen gas and caustic soda with the gas-liquid separator;
(d) injecting the caustic soda and carbon dioxide (CO₂) from a CO₂ source into the CO₂ absorption reactor to generate sodium carbonate or sodium bicarbonate;
(e) disposing the sodium carbonate or sodium bicarbonate in the acid-base reactor;
(f) reacting the chlorine gas and the electrolyte-containing chlorine gas with hydrogen in the second membrane reactor to produce hydrochloric acid and an electrical output;
(g) reacting the hydrochloric acid with sodium carbonate or sodium bicarbonate in acid and alkali reactor to produce CO₂; and
(h) releasing the CO₂.

In some aspects, the method further comprises transmitting an electricity output of the second membrane reactor to the first membrane reactor or to an external electricity grid.

In other aspects, the presently disclosed subject matter provides an eDAC system for capturing CO₂ comprising:
(a) hydrogen evolution reaction (HER) electrolyzer comprising an electrolyzer anode, an electrolyzer cathode, a first chamber, and a second chamber, wherein the first chamber comprises a redox mediate solution, wherein the redox mediate solution is contacting the electrolyzer anode, and the second chamber comprises a catholyte, wherein the catholyte is contacting the electrolyzer cathode, wherein the first chamber comprises an M^{x+} inlet and an M^{(x+1)} outlet, and (ii) the second chamber comprises a water inlet and an outlet for H₂ and caustic soda;
(b) electrolyte storage tanks, wherein a first electrolyte storage tank comprises (i) an inlet in fluid communication with the M^{(x+1)} outlet of the first chamber and (ii) an M^{(x+1)} outlet;
(c) a gas-liquid separator comprising (i) an inlet in fluid communication with the H₂ and caustic soda outlet of the second chamber, (ii) an H₂ outlet, and (iii) a NaOH outlet;
(d) a hydrogen storage tank comprising (i) an inlet in fluid communication with the H₂ outlet of the gas-liquid separator and (ii) an H₂ outlet;
(e) a hydrogen oxidation reaction (HOR) fuel cell comprising a gas-diffusion electrode, a fuel cell cathode, a third chamber and a fourth chamber, wherein the third chamber comprises an anolyte contacting the gas diffusion electrode (GDE), and wherein the fourth chamber comprises the redox mediate solution, wherein the redox mediate solution is contacting the fuel cell cathode, wherein the GDE is in fluid communication with the H₂ outlet of the hydrogen storage tank and wherein the fourth chamber comprises (i) an inlet in fluid communication with the M^{(x+1)} output of the first electrolyte storage tank and (ii) an M^{x+} outlet and an aqueous HCl solution outlet;
(f) a gas-liquid contactor comprising (i) a first inlet for CO₂, (ii) a second inlet in fluid communication with the NaOH outlet of the gas-liquid separator, and (iii) a NaHCO₃/Na₂CO₃ outlet; and
(g) an acid-base reactor comprising (i) a first inlet in fluid communication with the NaHCO₃/Na₂CO₃ outlet of the gas-liquid contactor, (ii) a second inlet in fluid communication an aqueous HCl outlet of the HOR fuel cell; and (iii) a pure CO₂ outlet;
wherein M is a metal selected from the group consisting of Fe, V, Cr, and Mn; and
x is an integer selected from 2, 3, and 4.

In some aspects, the eDAC system further comprises a fifth chamber for a brine solution, wherein the fifth chamber comprises an anion exchange membrane (AEM) and a cation exchange membrane (CEM), wherein the fifth chamber is positioned (i) between the first and second chambers in the HER electrolyzer such that the AEM is contacting the redox mediate solution and the CEM is contacting the catholyte, or (ii) between the third and fourth chamber in the HOR fuel cell such that the AEM is contacting the anolyte and the CEM is contacting the redox mediate solution.

In some aspects, the eDAC system further comprises a second electrolyte storage tank that comprises (i) an inlet in fluid communication with the M^{x+1} outlet of the fourth chamber and (ii) an M^{x+} inlet in the first chamber.

In some aspects, the fifth chamber of the eDAC system is positioned between the first and second chambers in the HER electrolyzer and wherein the HOR fuel cell further comprises an AEM positioned between the third and fourth chambers such that the AEM is contacting the anolyte and the redox mediate solution.

In some aspects, the eDAC system further comprises a sixth chamber comprising hydrogen gas contacting the GDE.

In some aspects, the eDAC system further comprises directly introducing the hydrogen gas to the GDE.

In some aspects, the fifth chamber of the eDAC system is positioned between the third and fourth chambers in the fuel cell unit and wherein the electrolyzer unit further comprises a CEM between the first and second chambers such that the CEM is contacting the redox mediate solution and the catholyte.

In some aspects, the system further comprises a module for receiving an electricity output from the HOR fuel cell and providing the electricity output to the HER electrolyzer.

In certain aspects, M is Fe or V.

In other aspects, the presently disclosed subject matter provides a method for capturing carbon dioxide from a carbon dioxide source, the method comprising:
(a) providing a eDAC system as described herein;
(b) oxidizing M^{x+} to M^{(x+1)} in the first chamber and storing the M^{(x+1)} in the first electrolyte storage tank;
(c) producing H₂ and caustic soda in the second chamber;
(d) separating the H₂ and caustic soda in the gas-liquid separator;
(e) storing the H₂ in the hydrogen storage tank;
(f) contacting the caustic soda with carbon dioxide (CO₂) from a CO₂ source in the CO₂ absorption reactor to generate sodium carbonate or sodium bicarbonate;
(h) introducing the M^{(x+1)} and H₂ into the HOR fuel cell to form M^{x+} and hydrochloric acid;
(i) injecting the hydrochloric acid and sodium carbonate or sodium bicarbonate into the acid-base reactor to form CO₂; and
(j) releasing the CO₂.

In some aspects, the method further comprises transmitting an electricity output of the HOR fuel cell to the HER electrolyzer or to an external electricity grid.

In some aspects of the one or more methods disclosed herein for capturing CO₂ from a CO₂ source, the carbon dioxide source comprises a dilute source of carbon dioxide. In certain aspects, the dilute source comprises ambient air. In certain aspects, the carbon dioxide source comprises a concentrated source of carbon dioxide. In particular aspects, the concentrated source of carbon dioxide comprises a point source of carbon dioxide. In more particular aspects, the point source of carbon dioxide comprises an effluent or gas stream from an industrial source. In yet more particular aspects, the industrial source is selected from the group consisting of an electrical power plant, a concrete plant, and a flue stack.

Certain aspects of the presently disclosed subject matter having been stated hereinabove, which are addressed in whole or in part by the presently disclosed subject matter, other aspects will become evident as the description proceeds when taken in connection with the accompanying Examples and Drawings as best described herein below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Having thus described the presently disclosed subject matter in general terms, reference will now be made to the accompanying Figures, which are not necessarily drawn to scale, and wherein:

FIG. 1 is a schematic of one embodiment of the presently disclosed electrochemistry-based direct air capture (eDAC) system;

FIG. 2 is a schematic of one embodiment of the presently disclosed electrochemistry-based direct air capture (eDAC) system showing an embodiment of the CO₂ absorption reactor;

FIG. 3 is a photograph showing a representative membrane-separated reactor of FIG. 1 for the production of Cl₂, H₂, and caustic soda;

FIG. 4 is a graph showing the concentration of NaOH (left axis) produced in the membrane-separated reactor of FIG. 1 and the relative pH of the electrolyte (right axis);

FIG. 5 shows the total captured CO₂ concentration with the electrochemistry-based direct air capture (eDAC) system of FIG. 1 using the atmosphere as a CO₂ source;

FIG. 6 shows the electrical voltage applied on the membrane-separated reactor of FIG. 1 with a current density of 100 mA/cm² during a 1-hour test.

FIG. 7 is a schematic of one embodiment of the presently disclosed electrochemistry-based direct air capture (eDAC) system coupled to an iron-based flow battery system;

FIG. 8 is a photograph showing that the state of charge (Fe³⁺-Fe²⁺ ratio) of the iron-based flow battery of FIG. 7 increases with an increase in current density from 0 mA, 50 mA, 100 mA, 150 mA, and 200 mA;

FIG. 9 shows the concentration of NaOH produced in the membrane-separated reactor of FIG. 7 as a function of current density;

FIG. 10 is a schematic of one embodiment of the presently disclosed carbon dioxide capture system coupled to a vanadium-based flow battery system (x=3.5);

FIG. 11 is another embodiment of an electrolyzer/fuel cell combination as described herein.

FIG. 12 is yet another embodiment of an electrolyzer/fuel cell combination as described herein.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

I. Electrochemical Capture of Carbon Dioxide from Air with Electricity Storage

Carbon dioxide capture technology can be divided into several categories including, but not limited to, chemical absorption, physical adsorption, membrane separation, cryogenic separation, and the like. The strong binding force of chemical absorption achieved through acid-base reaction, host-guest recognition, and other chemical actions helps to achieve high-efficiency absorption of CO₂ in a very low concentration CO₂ environment, such as the ambient atmosphere. Fasihi et al., 2019. Reasonably designed chemical circulation systems generally include a CO₂ absorption process and an absorbent regeneration process.

Existing DAC technologies typically rely on molecular adsorbents, for example, amine-based polymers, to selectively interact with CO₂ in air to achieve chemical separation. In capture processes based on chemical absorption, however, the chemical absorbent primarily combines with CO₂ through an acid-base interaction to achieve direct air capture. The capture process often is carried out spontaneously. The regeneration of the absorbent and release of CO₂, however, are non-spontaneous processes that consume energy.

Processes known in the art are mainly based on the thermal decomposition of specific CO₂ conjugates, such as calcium carbonate, Keith et al., 2018, and aniline bicarbonate with its derivatives. Hanusch et al., 2019. The heat energy required for these steps is often realized by a device driven by fossil energy, which, in turn, generates additional CO₂ emissions.

Despite the extensive efforts deployed on research in this area, this method is still challenged by the high energy intensity associated with the liberation of CO₂ and regeneration of sorbents. This process usually relies on temperature, pressure and/or humidity swing cycles. Molecular absorbents known in the art typically suffer from oxidative degradation during such swing cycles.

In contrast to DAC systems known in the art, the processes of absorbent regeneration and CO₂ recovery in the presently disclosed subject matter are based on an electrochemical system and an acid-base neutralization reaction. As a result, the processes can be completely driven by renewable electricity and carried out at room or intermediate temperature.

Electrochemical methods utilizing reversible redox pairs or ion pumps have been studied for capturing CO₂ from flue gas. Although some reversible redox pairs, such as 9,10-phenanthrenequinone (PAQ) and several organometallic complexes, have been shown to be more energy efficient than the amine-based thermochemical sorbents (owing to their relatively weak binding to CO₂), sluggish capture kinetics and high costs of such molecular sorbents largely limit their large-scale implementation.

Meanwhile, electrochemical pumps have been reported for CO₂ capture by using molten carbonate or aqueous alkaline fuel cells. Molten carbonate is a highly corrosive paste, however, and its operation requires high temperatures (for example, greater than 800° C.). An anion-exchange membrane in alkaline fuel cells has yet to be developed that is capable of tolerating the poisoning and deactivation caused by the high concentration of carbonate involved in the DAC process. Electrochemical pumps also suffer from the mismatching kinetics between the reaction with, for example, about 400 ppm CO₂, and the oxygen reduction reaction (ORR) that is typically utilized to drive the ionic current. Therefore, existing electrochemical CO₂ capture approaches are inappropriate for large-scale DAC applications.

Accordingly, there is a need for breakthroughs in the development of new sorbents that can be facilely (re)generated at high energy efficiency, new absorption chemistry that has fast kinetics for reaction with dilute CO₂ from air, and robust systems that are compatible with intermittent energy sources and implementable under various field conditions.

A comprehensive technology assessment of DAC systems published by The American Physical Society (APS) pointed out that the only industrially viable sorbents are inorganic hydroxides (e.g., NaOH or KOH) and monoethanolamine (MEA). To this end, without wishing to be bound to any one particular theory, it is thought that the use of an inorganic base can substantially boost the rate and capacity performance of DAC owing to the high exothermic nature of the reaction. Based on the acid-base reaction equilibria (pKa₁=6.35 for H₂CO₃/HCO₃ and pKa₂=10.33 for HCO₃⁻/CO₃²⁻), the absorption capacity of 1 mol/L NaOH is estimated to range from about 6.8 to about 13.6 mmol-CO₂/g-NaOH, corresponding to the pH range of about 10.01 to about 11.39 for the outlet solution. These values are substantially higher than the typical working capacity of less than about 3 mmol-CO₂/g for amine-based sorbents. In addition, over 80% of the absorption capacity can be achieved over a short contact time by taking advantage of the fast kinetics of acid-base reactions.

Accordingly, the presently disclosed subject matter provides systems and methods of their use for the low-cost and highly-efficient direct air capture (DAC) of CO₂ from the ambient atmosphere and other CO₂ sources, including, but not limited to, low-concentration CO₂ sources. As used herein, the terms “ambient air” or “ambient atmosphere” are used interchangeably and refer to “that portion of the atmosphere, external to buildings, to which the general public has access.” See 40 C.F.R. § 50.1(e). Further, the term “atmosphere” as used herein generally refers to the troposphere, which is the lowest region of the atmosphere, extending from the earth's surface to a height of about 3.7-6.2 miles (6-10 km), and is the lower boundary of the stratosphere. The current concentration of CO₂ in the troposphere is about 400 ppm.

The presently disclosed systems and methods provide for CO₂ release and absorbent regeneration based on electrochemistry and acid-base neutralization. Compared with the thermochemical decomposition method and the membrane exchange method known in the art, the presently disclosed systems and methods have the advantages of low energy consumption and simplicity of the system.

Importantly, the presently disclosed approach is based on robust acid-base chemistries. Carbon dioxide capture is highly cost-sensitive for both capital and operating costs. To address this cost-sensitivity, the presently disclosed subject matter is based on low-cost general chemicals rather than expensive specialized chemicals. As such, the presently disclosed technology can be combined with existing industrial environments, such as the existing brine/seawater electrolysis industry, to achieve low-cost and highly-efficient direct air capture (DAC) of CO₂. In addition, the presently disclosed technology is scalable and can be directly applied to various existing renewable power generation equipment, in part, because the technology is based on room temperature or medium temperature reaction equipment and can achieve its own thermal energy balance through delicate heat exchange between multiple unit operations.

As used herein, the term “room temperature” refers to a temperature of about 25° C., including, in some embodiments, a temperature range from about 1° C. to about 30° C., including 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30° C., in other embodiments, a temperature range from about 15° C. to about 30° C., including about 15, 16, 17, 18, 19, 20, 21, 22, 23, 24, 25, 26, 27, 28, 29, and 30° C., in other embodiments, a temperature range from about 15° C. to about 25° C., including about 15, 16, 17, 18, 19, 20, 21, 22, 23, 24, and 25° C., and in some embodiments, a temperature range from about 20° C. to about 25° C., including about 20, 21, 22, 23, 24, and 25° C.

As used herein, the term “medium temperature” refers to a temperature between about 30° C. to about 250° C., including 30, 40, 50, 60, 70, 80, 90, 100, 110, 120, 130, 140, 150, 160, 170, 180, 190, 200, 210, 220, 230, 240, and 250° C.

Accordingly, in some embodiments, the presently disclosed subject matter provides an electrochemistry-based CO₂ capture system, which is significantly less energy intensive than the current state-of-the-art CO₂ capture systems and has an all-liquid high efficiency reaction system with the capability to achieve large-scale chemical storage of electricity from an electrical grid or other electricity source. As a result, the presently disclosed system can be implemented to capture CO₂ from the ambient atmosphere and other CO₂ sources and store electrical energy simultaneously.

The utility of this approach is twofold. First, the direct capture of CO₂ can address the problem of excessive CO₂ emission in the atmosphere. Second, the storage of electrical energy can improve the efficiency of renewable energy. Accordingly, the presently disclosed subject matter can be used in clean energy, the chemical and petrochemical industry, and in smart electricity grids, and, in general, any factory or institution that implements industrialized carbon emission reduction.

A. Renewable Capture of CO₂ from Air Using Electrochemically Produced Acid and Base

In one embodiment, the presently disclosed subject matter provides an electrochemical system including an electrolytic cell for chlor-alkali process, a hydrogen-chlorine fuel cell, a gas-liquid separator, a CO₂ absorber, and an acid-base reactor.

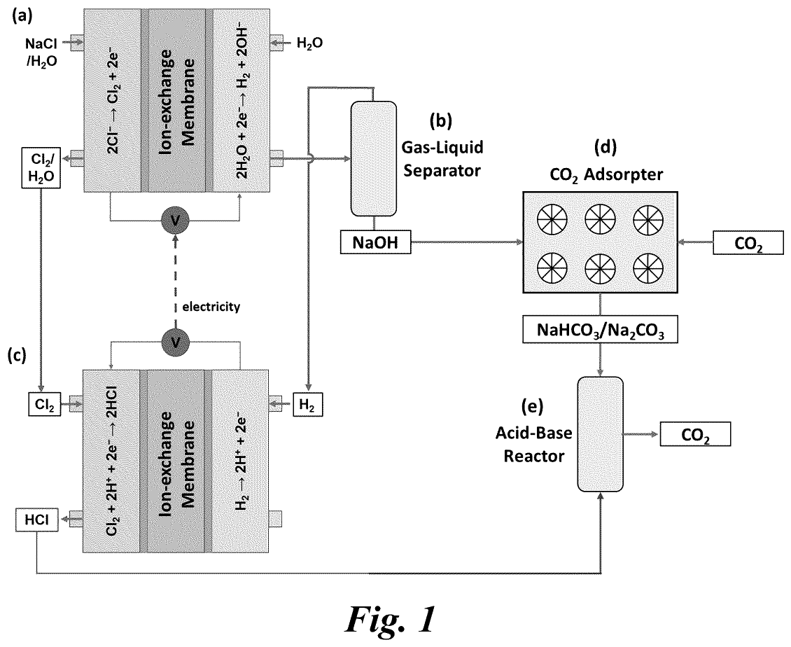

Referring now to FIG. 1, in some embodiments, the presently disclosed DAC technology (referred to herein as “eDAC”) comprises five unit operations: (i) a chlor-alkali electrolyzer that converts brine (NaCl+H₂O) into caustic soda (NaOH), H₂, and Cl₂ (FIG. 1a); ii) a gas-liquid separator (FIG. 1b); iii) an alkaline scrubbing tower allowing for efficient air-liquid contact and CO₂ capture (FIG. 1d); iv) a proton-exchange membrane fuel cell (PEMFC) that recombines H₂ and Cl₂ to produce HCl (FIG. 1c); and v) a continuously stirred-tank reactor (CSTR) that carries out the acid-base reaction between Na₂CO₃/NaHCO₃ and HCl (FIG. 1e).

More particularly, as provided in FIG. 1, in some embodiments, the presently disclosed subject matter provides an electrochemical system for capturing carbon dioxide, the system comprising:
(a) a first membrane reactor comprising an ion-exchange membrane operationally positioned between an anode chamber and a cathode chamber, wherein the anode chamber comprises an inlet in fluid communication with a brine source and an outlet for Cl₂/H₂O and wherein the cathode chamber has a water inlet and an outlet for H₂ and caustic soda;
(b) a gas-liquid separator comprising an inlet in fluid communication with the outlet for H₂ and caustic soda of the cathode chamber of the first membrane reactor and a first outlet for H₂ and a second outlet for NaOH;
(c) a second membrane reactor comprising an ion-exchange membrane operationally positioned between an anode chamber and a cathode chamber, wherein the anode chamber has an inlet for Cl₂ in fluid communication the outlet of the anode chamber of the first membrane reactor and an outlet for HCl and wherein the cathode chamber has an inlet in fluid communication with the H₂ outlet of the gas-liquid separator and an outlet for aqueous NaOH solution;
(d) a CO₂ absorption reactor, wherein the CO₂ absorption reactor has an inlet for introducing CO₂ from a CO₂ source, an inlet for caustic soda in fluid communication with the gas liquid separator, and an outlet for NaHCO₃/Na₂CO₃; and
(e) an acid-base reactor comprising a first inlet in fluid communication with the HCl outlet of the anode chamber of the second membrane reactor and a second inlet in fluid communication with the NaHCO₃/Na₂CO₃ outlet of the CO₂ absorption reactor and a first outlet in fluid communication with the brine source and a second outlet for releasing CO₂;
wherein the second membrane reactor is configured to produce an electricity output and is in electrical communication with the first membrane reactor.

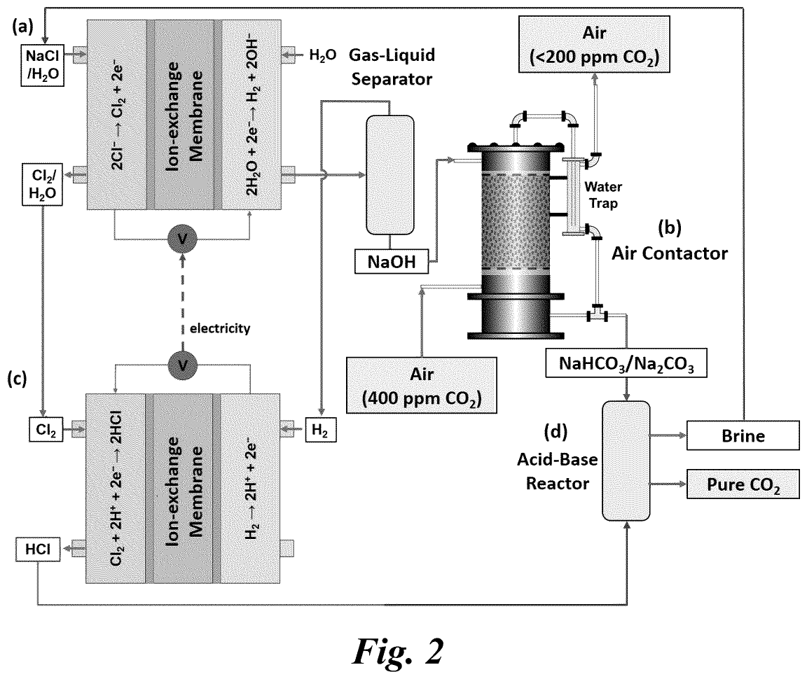

Referring now to FIG. 2, is an embodiment of the presently disclosed electrochemistry-based direct air capture system showing an embodiment of the CO₂ absorption reactor comprising a water trap that partially removes water from the outlet of post-absorption air to reduce the water cost for the whole system.

One of ordinary skill in the art would recognize that different parameters and unit specifications can affect the performance of the CO₂ capture system. Ion exchange membranes, absorbent concentration and flow rates are major factors that influence the efficiency and cost of carbon dioxide capture in this system.

A variety of ion exchange membranes as well as their combinations can meet the electrochemical reaction needs of the system. As shown in FIG. 1, both membrane reactors (a) and (c) can use a cation exchange membrane (or a proton exchange membrane) to separate the reaction medium between two electrodes. In this condition, the cation (or proton) will transfer from anode chamber to cathode chamber. Also, both membrane reactors (a) and (c) can use an anion exchange membrane (or a hydroxyl exchange membrane) to separate the reaction medium between two electrodes while the anion (or hydroxyl) will transfer from cathode chamber to anode chamber. Similarly, reactors (a) and (c) can also use different ion exchange membranes or combinations of multiple exchange membranes to improve the performance of the single reactor.

Referring again to FIG. 1, in one embodiment, the presently disclosed subject matter provides a method for capturing CO₂ from a CO₂ source comprising:
(i) introducing CO₂ from a CO₂ source into an inlet of an CO₂ absorption reactor (d);
(ii) introducing brine into an anode chamber of an electricity-driven membrane reactor (a) comprising an anode chamber and a cathode chamber, thereby electrolyzing the brine and producing chlorine gas and electrolyte-containing chlorine gas in the anode chamber and hydrogen gas and caustic soda in the cathode chamber;
(iii) separating the hydrogen and caustic soda with a gas-liquid separator (b);
(iv) injecting the caustic soda into the CO₂ absorption reactor (d) and reacting the caustic soda with the carbon dioxide of step (i) to generate sodium carbonate or sodium bicarbonate;
(v) disposing the sodium carbonate or sodium bicarbonate in acid-base reactor (e);
(vi) reacting the chlorine gas and the electrolyte-containing chlorine gas with hydrogen in membrane reactor (c) to produce hydrochloric acid and an electrical output;
(viii) reacting the hydrochloric acid with sodium carbonate or sodium bicarbonate in acid and alkali reactor (e); and
(ix) releasing carbon dioxide from the acid and alkali reactor.

In certain embodiments, the electrical energy output at least partially compensates an energy input required for electrolyzing the brine at membrane reactor (a).

As provided hereinabove, compared to existing DAC technologies known in the art, the presently disclosed eDAC takes advantage of an ambient-condition acid-base reaction to capture and release CO₂. This process is believed to be much faster in kinetics with barrierless reactions, more energy-efficient by avoiding a high-temperature swing/calcination process, and more sustainable by leveraging renewable (but intermittent) energy sources.

Further, to avoid energy-intensive desorption using a temperature swing, the regeneration of captured CO₂ also can be achieved by adding in-situ produced HCl to the sodium (bi)carbonate solution, where the acid-base reaction can be accomplished under ambient conditions (for example, see FIG. 1e). In the presently disclosed eDAC system, the capture and release of CO₂ are completely decoupled. A chlor-alkali electrolyzer (FIG. 1a) and a H₂—Cl₂ fuel cell (FIG. 1c) can be deployed to produce the base (NaOH) and acid (HCl) on site, respectively.

The presently disclosed electrochemical systems possess high energy conversion efficiencies as compared to conventional thermochemical syntheses, and moreover, when integrated, can substantially reduce the energy consumption for the simultaneous production of acid and base demanded for the eDAC. Together with the closed mass balance by recirculation of NaCl (derived from the CO₂ regeneration reactions, R1 or R2 immediately herein below, the presently disclosed acid-base chemistries can enable robust, energy-efficient and cost-effective DAC under various field conditions.

NaHCO₃+HCl→NaCl+H₂O+CO₂ R1:

Na₂CO₃+2HCl→2NaCl+H₂O+CO₂ R2:

In some embodiments, the CO₂ absorption reactor captures CO₂ from a gas source comprising carbon dioxide and reacts the CO₂ with the electro-synthesized caustic soda. In some embodiments, the CO₂ absorption reactor comprises a device wherein the gas source comprising CO₂ comes in contact with at least a portion of the as-synthesized caustic soda from the first membrane reactor to produce an aqueous solution comprising a solubilized carbonate, e.g., NaHCO₃/Na₂CO₃. CO₂ absorption reactors are well known in the art. For example, in some embodiments, a CO₂ absorption reactor comprises a column, wherein the column is packed with beads or comprises a membrane contactor.

The gas source comprising CO₂ is contacted with at least a portion of the caustic soda in a column of the CO₂ absorption reactor removing some of the CO₂ from the gas source and producing a carbonate solution, which is directed to acid-base reactor of the eDAC system. In some embodiments, the gas source comprising CO₂ is contacted with at least a portion of the as-synthesized caustic soda in a countercurrent manner within the CO₂ absorption reactor.

In some embodiments, the gas source is air. In some embodiments, the gas source is obtained from various industrial sources that release carbon dioxide including carbon dioxide from combustion gases of fossil fueled power plants, e.g., conventional coal, oil and gas power plants, or IGCC (Integrated Gasification Combined Cycle) power plants that generate power by burning syngas; cement/concrete manufacturing plants that convert limestone to lime; ore processing plants; fermentation plants; and the like. In some embodiments, the gas source may comprise other gases, e.g., nitrogen, oxides of nitrogen (nitrous oxide, nitric oxide), sulfur and sulfur gases (sulfur dioxide, hydrogen sulfide), and vaporized materials. In some embodiments, the system includes a gas treatment system that removes at least a portion of the other gases in the gas source before the gas source is introduced to the CO₂ absorption reactor.

The carbonate solution, e.g., NaHCO₃/Na₂CO₃, from the CO₂ absorption reactor can be introduced into the acid-base reactor with at least a portion of the as-synthesized HCl from the second membrane reactor to produce a brine solution and CO₂(g). In some embodiments, the acid-base reactor comprises a continuously stirred tank reactor. In some embodiments, at least a portion of the brine solution can be directed to the brine source in fluid communication with the first membrane reactor. The CO₂ is vented from the acid-base reactor. Neutralizers are well known in the art.

Although not shown in FIG. 1, in some embodiments, some portion of the caustic soda and some portion of the HCl is instead collected as an acid solution and a base solution for commercial use. In some embodiments, all of the caustic soda is directed to the CO₂ absorption reactor. In some embodiments, all of the HCl is directed to the acid-base reactor.

It should be noted that the eDAC system and methods disclosed herein are distinct from the previously reported electrochemical pumps. Referring once again to FIG. 1, the electrolyzers and fuel cells employed in the presently disclosed eDAC system are used to produce acid and base, which is used to capture and release CO₂ in separate units. Such decoupling of the acid/base production from the CO₂ separation step is a key in addressing the dilemma between capture kinetics and regeneration energy consumption in eDAC systems.

Further, the chlor-alkali electrolyzer (FIG. 1a) and the H₂—Cl₂ fuel cell (FIG. 1c) in the presently disclosed eDAC system can leverage commercialized electrochemical devices that have been demonstrated to be suitable for scalable manufacturing. Additionally, NaOH can be manufactured on a large scale using commercialized chlor-alkali processes, with hydrogen (H₂) and chlorine (Cl₂) as byproducts (FIG. 1a). Advanced membrane reactor design, electrodes (e.g., dimensionally stable anodes (DSA®)) (Industrie De Nora S.p.A., Milan, Italy), for the chlorine evolution reaction (ClER) and cell parts (membrane and bipolar plates that are compatible with alkaline and Cl₂) can be used to provide advanced chlor-alkali electrolyzers to establish and optimize the operation parameters for NaOH production.

For example, in representative embodiments, starting from a laboratory-scale membrane reactor, the electrolyzer can be stepwise scaled-up to 200 cm² to achieve the production of 1-M NaOH at 60 L/day. In combination with the development of advanced ClER and hydrogen evolution reaction (HER) electrocatalysts, a high Faradaic efficiency of greater than 96% and lower cell voltage of less than 3 V can be achieved at a high current density of 400 mA/cm² in a laboratory-scale reactor. The energy efficiency for the system can reach up to 70.5% in such chlor-alkali systems.

With the two side-product streams, H₂ and Cl₂, derived from the chlor-alkali process, HCl can be facilely generated via direct electrolysis using a proton-exchanged membrane fuel cell (PEMFC) (FIG. 1c). The coupling of the chlorine reduction reaction (ClRR) and hydrogen oxidation reaction (HOR) give an equilibrium voltage of about 1.36 V, and the generated electrical energy can be used to compensate the energy consumption of the chlor-alkali electrolyzer (FIG. 1c) or drive the air flow (blower or compressor) for CO₂ capture (FIG. 1b).

Since H₂ and Cl₂ are produced synchronously in a 1:1 stoichiometric ratio from the chlor-alkali process, the coupling of a H₂—Cl₂ fuel cell with the electrolyzer can close the mass balance and produces HCl stoichiometrically, which can then be used to neutralize the (bi)carbonate solution derived from the CO₂ absorption reactor (FIG. 1d) and regenerate the captured CO₂ (FIG. 1e).

Absorbent concentration is an important factor that can affect the absorption process efficiency of CO₂ in the absorption unit. A high-concentration caustic soda solution will greatly improve the absorption efficiency and obtain a solution with high total CO₂ absorption. Caustic soda solution with a concentration between about 0.01 mol/L to about 15 mol/L, including 0.1, 0.2, 0.3, 0.4, 0.5, 0.6, 0.7, 0.8, 0.9. 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, and 15 mol/L can effectively absorb CO₂.

For example, in a system using 1-mol/L caustic soda as an absorbent, each ton of carbon dioxide captured from the air will consume 505 kWh of electricity, including 1333 kWh of electricity consumed by the chlor-alkali electrolysis cell and −828 kWh of electricity compensated by hydrogen-chlorine fuel cells. This power utilization efficiency far exceeds the existing thermochemical process-based capture system.

Further, it has been shown that the aqueous fuel cell adopting flowing liquid catholyte can accommodate higher current density and provide better cell stability as compared to the anhydrous cell. Owing to the high hydrophilicity of the product HCl, most of the water will be removed from the cell when it is operated under anhydrous conditions, and this process increases the membrane resistance and ultimately causing membrane damage, which decreases the cell performance.

By using (Ru_{0.09}Co_{0.91})₃O₄ as the electrocatalyst for chlorine reduction, this type of H₂—Cl₂ fuel cell exhibited extremely low activation losses even with low precious metal loading (approximately 0.15 mg Ru/cm²). It delivered 0.4 W/cm² with 90% Faradaic efficiency, and the maximum power density exceeded 1 W/cm². The cell operating pressure also plays an important role in the discharge performance. Increasing the pressure from 12 psig to 70 psig results in a maximum power density increasing from 0.4 W/cm² to 1 W/cm². The primary impact of increasing cell pressure is dissolving more Cl₂ into the electrolyte, consequently, improving the mass transfer to the electrochemical interface and catalyst.

Further, the development of aqueous H₂—Cl₂ fuel cells uses diluted HCl as feeding anolyte to derive a concentrated HCl solution. According to the literature, an output current density of up to 400 mA/cm² can be achieved at a voltage of 1.0 V with the production of 3 mol/L HCl. By coupling with a best-performing chloro-alkali electrolyzer, an overall energy efficiency of 61% (calculated as 1−(2.19 V—1.36 V)/(2.19 V/EE_{chlor-alkali}−1.36V*EE_{fuel cell}) can be targeted for the production of base and acid media for the eDAC, which is substantially higher than the typical energy efficiency of 10-20% (2 MWh/ton in use versus the theoretical energy consumption of approximately 250 kWh/ton) for existing DAC technologies.

A techno-economic assessment (TEA)-driven approach can be applied to achieve optimal parameters for the presently disclosed eDAC technology. This approach will be achieved by first performing mass and energy balance calculations and modeling the (electro)chemical processes using ASPEN Plus. A preliminary TEA shows that building a commercial plant with the process capability of 1 MtCO₂ per year will generate a capital cost of $320-363/ton-CO₂ per year. The key instruments for such a plant are the electrolyzer/fuel cell and the adsorption towers as CO₂ absorption reactor. Electricity is a major part of the operation cost which is highly dependent on the electricity price and system energy efficiency. In general, the energy cost will be less than $50 per ton of captured CO₂ with 60% energy efficiency at the electricity price of $0.02 per kWh. In our preliminary TEA with $0.02/kWh, a first-of-a-kind (FOAK) DAC plant in this scale without a large government incentive (e.g., carbon credit) would be at ˜$142/tCO₂ in total while the Nth DAC plant can reduce the levelized cost to ˜$107/ton-CO₂ (Table 1). If off-peak electricity can be used at lower prices, the levelized cost of the eDAC can even go substantially lower in practice, e.g., <$100/ton at $0.015/kWh.

TABLE 1
Preliminary TEA result, to be further developed during project
implementation.

| | | First-of-a-kind | Nth-Plant |
|---|---|---|---|
| Economic Variable | Units | Commercial | Commercial |
| CO₂ Production Capacity | tons/year | 1000000 | 1000000 |
| Capital Costs | $M | 362.78 | 319.50 |
| Operating Costs | $M/year | 65.01 | 47.84 |
| DAC CO₂ Price | $/ton | 142.10 | 107.83 |

### B. Renewable Capture of CO₂ Using Reversible Redox Pairs

In some embodiments, the presently disclosed subject matter provides an electrochemistry-based CO₂ capture system and flow battery system. This system can be operated with various types of flow batteries based on different redox pairs, e.g., redox mediates, including, but not limited to, Fe²⁺/Fe³⁺, V²⁺/V³⁺, V⁴⁺/V⁵⁺, Cr(III)/Cr(VI), Mn(II)/Mn(III), and the like, which can be represented as M^{x+}/M^{(x+1)}, wherein M is a metal selected from the group consisting of Fe, V, Cr, and Mn and X is an integer selected from 2, 3, and 4.

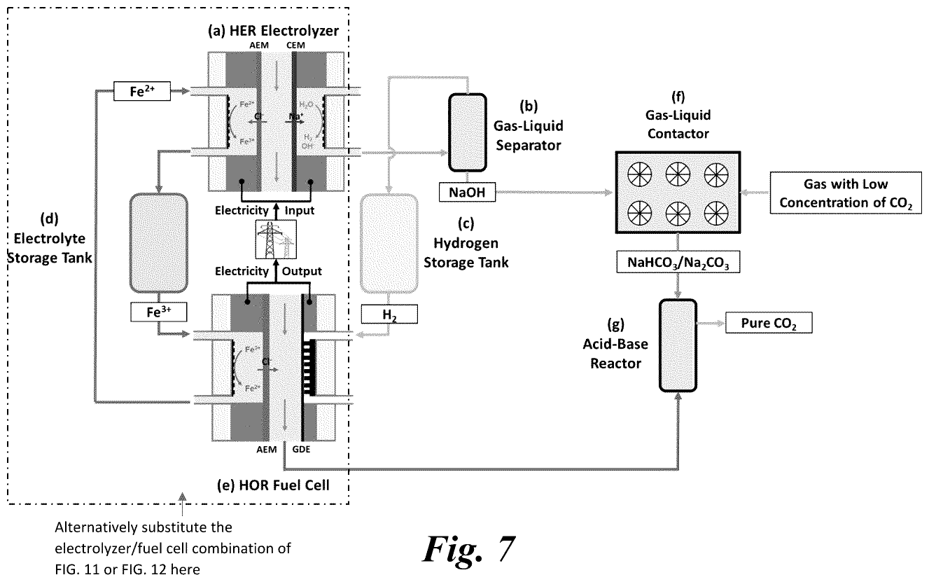

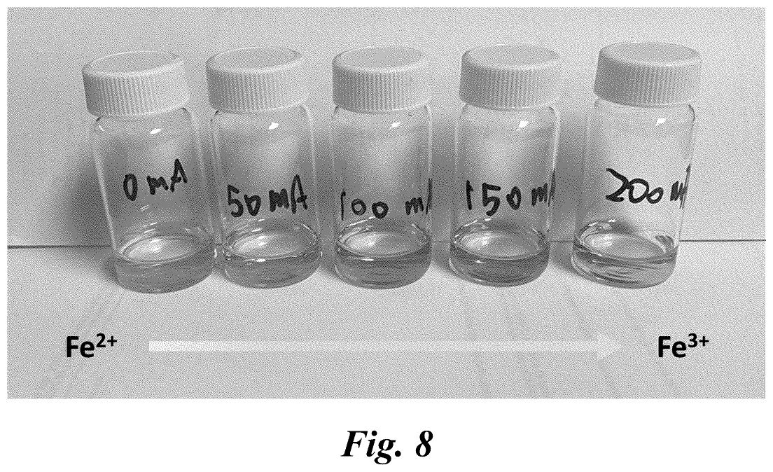

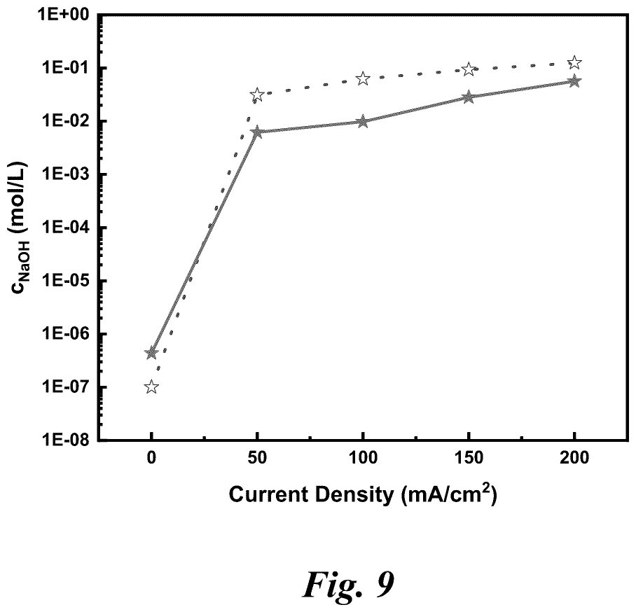

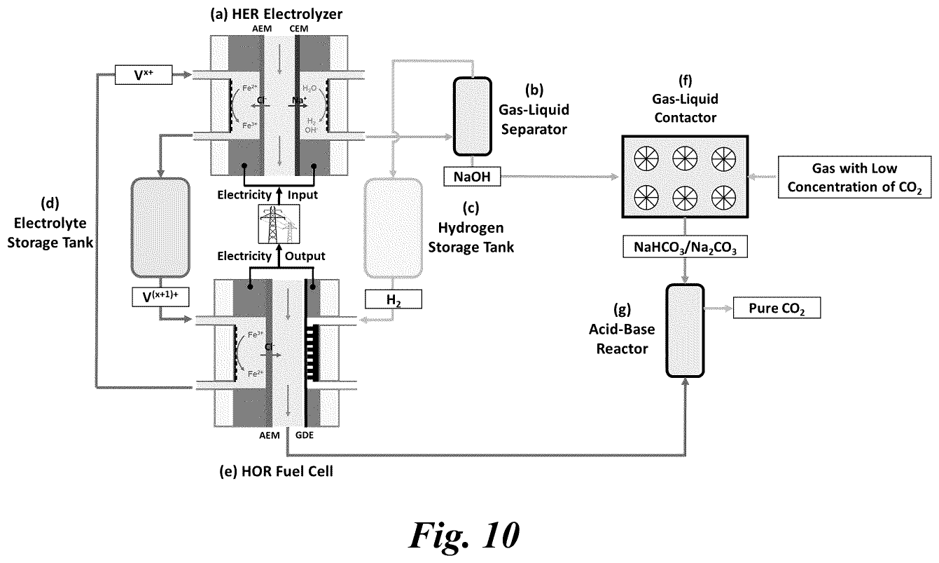

Referring now to FIG. 7, in a representative embodiment, the presently disclosed subject matter provides an electrochemistry-based CO₂ capture system and iron-based flow battery system. Referring once again to FIG. 7, in one embodiment, the presently disclosed electrochemical system for capturing CO₂, e.g., eDAC, comprises:
(a) a hydrogen evolution reaction (HER) electrolyzer comprising (i) a HER anode chamber wherein an anolyte can be in contact with an anode for converting M^{x+} to M^{(x+1)}, e.g., Fe²⁺ to Fe³⁺, and an anion-exchange membrane (AEM), wherein the HER anode chamber comprises an M^{x+} (e.g., Fe²⁺) inlet and an M^{(x+1)} (e.g., Fe³⁺) outlet, (ii) a brine chamber positioned between the AEM and a cation exchange membrane (CEM), and (iii) a HER cathode chamber wherein a catholyte can be in contact with a cathode and the CEM, wherein the HER cathode chamber comprises a water inlet and an outlet for H₂ and caustic soda (i.e., NaOH);
(b) a gas-liquid separator comprising (i) an inlet in fluid communication with the H₂ and caustic soda outlet from the HER cathode chamber, (ii) an H₂ outlet, and (iii) a NaOH outlet;
(c) a hydrogen storage tank comprising (i) an inlet in fluid communication with the H₂ outlet of the gas-liquid separator and (ii) an H₂ outlet;
(d) a first electrolyte storage tank comprising (i) an inlet in fluid communication with the M^{(x+1)} (e.g., Fe³⁺) outlet of the HER anode chamber and (ii) an M^{(x+1)} (e.g., Fe³⁺) outlet;
(e) a hydrogen oxidation reaction (HOR) fuel cell comprising a HOR cathode chamber and a HOR anode chamber, wherein a catholyte in the HOR cathode chamber can be in contact with a cathode for converting M^{(x+1)} to M^{x+}, e.g., Fe³⁺ to Fe²⁺, and an AEM, wherein the HOR cathode chamber comprises (i) an inlet in fluid communication with the M^{(x+1)} (e.g., Fe³⁺) output of the first electrolyte storage tank and (ii) an M^{x+} (e.g., Fe²⁺) outlet, and wherein an anolyte in the HOR anode chamber is in contact with the AEM and a gas diffusion electrode (GDE), wherein the GDE comprises (i) an inlet in fluid communication with the H₂ outlet of the hydrogen storage tank and (ii) optionally an H₂O outlet or no outlet, and the HOR anode chamber comprises an outlet for the final product in the HOR fuel cell, i.e., aqueous HCl solution;
(f) a gas-liquid contactor, e.g., a CO₂ absorption reactor as described herein, comprising
(i) a first inlet for CO₂, (ii) a second inlet in fluid communication with the caustic soda outlet of the gas-liquid separator, and (iii) a NaHCO₃/Na₂CO₃ outlet; and
(g) an acid-base reactor, e.g., as described herein, comprising (i) a first inlet in fluid communication with the NaHCO₃/Na₂CO₃ outlet of the gas-liquid contactor, (ii) a second inlet in fluid communication the aqueous HCl solution outlet of the HOR fuel cell; and (iii) a pure CO₂ outlet,
wherein the eDAC system further comprises a second electrolyte storage tank comprising (i) an inlet in fluid communication with the M^{x+} (e.g., Fe²⁺) outlet of the HOR cathode chamber and (ii) an M^{x+} (e.g., Fe²⁺) outlet in communication with the HER anode chamber.

In some embodiments, the system further comprises an energy recovery unit for receiving an electricity output from the HOR fuel cell and providing the electricity output to the HER electrolyzer. As such, the HOR fuel cell is capable of generating electricity during operation. The generated electricity can be applied to the electrolyzer so that the energy consumption or energy needed from an electricity grid is reduced. Generally, any of the systems disclosed herein can include an energy recovery unit.

Referring again to FIG. 7, in one embodiment, the presently disclosed subject matter provides a method for capturing CO₂ from a CO₂ source wherein: the electrolyte is first electrolyzed by the electricity-driven membrane reactor (a), the iron battery is charged in the anode chamber as Fe²⁺ is oxidized into Fe³⁺ as outlet liquid flow, and hydrogen gas and caustic soda are produced in the cathode chamber. After the hydrogen and caustic soda are separated by the gas-liquid separator (b), the caustic soda solution is injected into the CO₂ absorption reactor
(f) and reacts with the CO₂ source to generate sodium carbonate or sodium bicarbonate solution. At the same time, charged anolyte containing Fe³⁺ and hydrogen are stored in the first electrolyte storage tank (d) and hydrogen storage tank (c), separately, as the chemical storage of electricity.

Once needed, the charged anolyte and hydrogen is introduced into a membrane-based fuel cell (e) to produce discharged catholyte containing Fe²⁺ in the HOR cathode chamber and hydrochloric acid solution in the HOR anode chamber. The electrical energy output partially compensates the energy of the membrane reactor (a) electrolysis or puts into the electricity grid for other usage, and the hydrochloric acid solution generated at the same time neutralizes the reaction in the acid and alkali reactor (g) by reacting with sodium carbonate or sodium bicarbonate produced after absorption, and CO₂ is released as a pure gas.

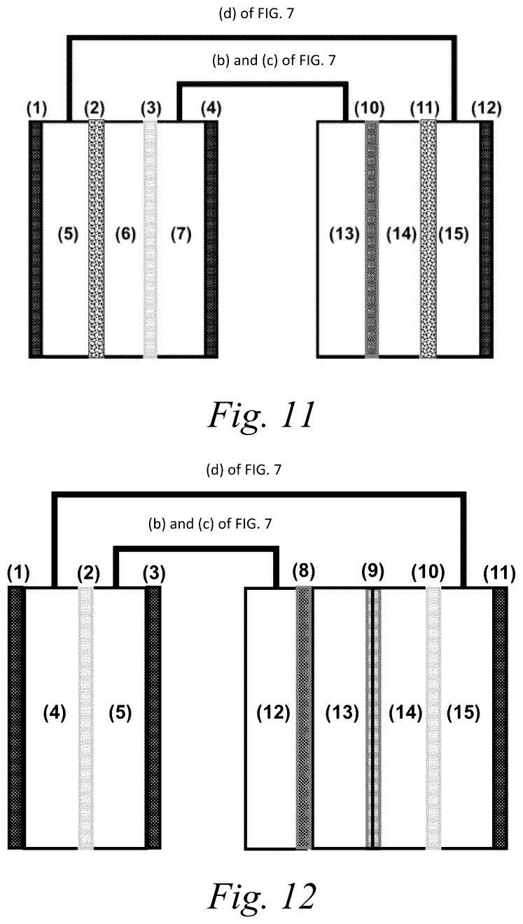

In another embodiment, the electrolyzer/fuel cell combination of FIG. 7 (e.g., as shown in the dashed box in FIG. 7) are replaced by the electrolyzer/fuel cell combination illustrated in FIG. 11 or FIG. 12. It should be appreciated that the electrolyzer/fuel cell combination of FIG. 11 or FIG. 12 is merely illustrating an alternative arrangement of an electrolyzer in combination with a fuel cell. The electrolyzer/fuel cell combination of FIG. 11 or FIG. 12 are intended to be substituted into the dashed box of the eDAC system of FIG. 7, and attached to the remainder of the components shown in FIG. 7.

In the electrolyzer/fuel cell combination illustrated in FIG. 11, the electrochemical system comprises, consists of, or consists essentially of (A) an electrolyzer unit for base making and the oxidation of the redox mediate pairs (1-7); (B) a hydrogen separation and transfer unit, e.g., the combination gas-liquid separator (b) and hydrogen storage tank (c) of FIG. 7; (C) a redox pair storage and transfer unit, e.g., electrolyte storage tanks (d) of FIG. 7; and (D) a fuel cell unit for acid making and the reduction of the redox mediate pairs (10-15). In the electrolyzer unit, three chambers are separated by two membranes: an AEM (2) between chambers (5) and (6) and a CEM (3) between chambers (6) and (7), wherein redox mediates are in anode chamber (5), brine solution is in chamber (6), and a catholyte comprising an alkaline solution is in cathode chamber (7). In the fuel cell unit, three chambers are separated by two membranes: an anion-exchange membrane (11) between chambers (14) and (15) and a gas diffusion electrode (10) between chambers (13) and (14), wherein hydrogen gas is introduced to chamber (13), an anolyte comprising a dilute acid solution is in anode chamber (14), and redox mediates are in the cathode chamber (15). Under an applied voltage across the electrolyzer anode and the electrolyzer cathode, (i) on the electrolyzer anode (1), the redox mediates are electro-oxidized into their oxidation form, e.g., M^{x+} to M^{(x+1)}, e.g., Fe²⁺ to Fe³⁺, and (ii) on the electrolyzer cathode (4), the water in the dilute alkaline solution is electro-reduced into hydrogen gas and hydroxide ions, which are both directed to the gas-liquid separator. The as-synthesized hydrogen gas is directed to chamber (13) in the fuel cell and the as-synthesized hydroxide ions are directed to the CO₂ absorption reactor (e.g., as shown in FIG. 7). Under an applied voltage across the gas-diffusion-electrode and the fuel cell cathode, (iii) on the fuel cell cathode (12), the redox mediates are electro-reduced into their reduction form, e.g., M^{(x+1)} to M^{x+}, e.g., Fe³⁺ to Fe²⁺, and (iv) on the gas-diffusion-electrode-based electrode (10), the hydrogen gas is electro-oxidized into the anolyte in anode chamber (14) and the H⁺ ions are generated in chamber (14) and flowed out to the acid-base reactor.

In the electrolyzer/fuel cell combination illustrated in FIG. 12, the electrochemical system comprises, consists of, or consists essentially of (A) an electrolyzer unit for base making and the oxidation of the redox mediate pairs (1, 3-5, 7); (B) a hydrogen separation and transfer unit, e.g., the combination gas-liquid separator (b) and hydrogen storage tank (c) of FIG. 7; (C) a redox pair storage and transfer unit, e.g., electrolyte storage tanks (d) of FIG. 7; and a (D) fuel cell unit for acid making and the reduction of the redox mediate pairs (2, 6, 10-15). In the electrolyzer unit, two chambers (5) and (7) are separated by a CEM (3), wherein redox mediates are in anode chamber (5) and a cathode electrolyte comprising a dilute alkaline solution is in cathode chamber (7). In the fuel cell unit, four chambers are separated by two ion-exchange membranes—an anion-exchange membrane (2) between chambers (6) and (14) and a cation-exchange membrane (11) between chambers (6) and 15)—and one gas diffusion electrode (10) between chambers (13) and (14), wherein hydrogen gas is introduced to chamber (13), redox mediates are in cathode chamber (15), brine solution is in chamber (14) and an anode electrolyte comprising a dilute acid solution is in anode chamber (14). Under an applied voltage across the electrolyzer anode and the electrolyzer cathode, (i) on the electrolyzer anode (1), the redox mediates are electro-oxidized into their oxidation form, e.g., M^{x+} to M^{(x+1)}, e.g., Fe²⁺ to Fe³⁺, and (ii) on the electrolyzer cathode (4), the water in the dilute alkaline solution (7) is electro-reduced into hydrogen gas and hydroxide ions, which are both directed to the gas-liquid separator. The as-synthesized hydrogen gas is directed to chamber (13) in the fuel cell and the as-synthesized hydroxide ions are directed to the CO₂ absorption reactor (e.g., as shown in FIG. 7). Under an applied voltage across the gas-diffusion-electrode and the fuel cell cathode, (iii) on the fuel cell cathode (12), the redox mediates are electro-reduced into their reduction form, e.g., M^{(x+1)} to M^{x+}, e.g., Fe³⁺ to Fe²⁺, and on the gas-diffusion-electrode-based anode (10), the hydrogen gas is electro-oxidized into the anolyte in anode chamber (14) and the H⁺ ions are generated in chamber (14) and flowed out to the acid-base reactor.

One of ordinary skill in the art would recognize that further modifications of the presently disclosed system can be made to improve its performance without changing the chemical reactions of the system and accommodate other important gaseous capture processes.

In some embodiments, the acid produced is selected from the group consisting of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, and acetic acid. In some embodiments, the acid produced is HCl. In some embodiments, the base produced is selected from the group consisting of sodium hydroxide, lithium hydroxide, potassium hydroxide, magnesium hydroxide, calcium hydroxide, and sodium acetate.

Although reference is made in FIG. 7 to NaCl(aq) as the brine solution, in some embodiments, the brine solution is an aqueous solution comprising a salt selected from the group consisting of sodium chloride, potassium chloride, lithium chloride, sodium bromide, potassium bromide, lithium bromide, sodium iodide, potassium iodide, lithium iodide, sodium sulfite, potassium sulfite, lithium sulfite, sodium sulfate, potassium sulfate, lithium sulfate, sodium nitrate, potassium nitrate, lithium nitrate, sodium nitrite, potassium nitrite, lithium nitrite, sodium phosphite, potassium phosphite, lithium phosphite sodium phosphate, potassium phosphate, lithium phosphate, sodium hypochlorite, potassium hypochlorite, lithium hypochlorite, sodium chlorite, potassium chlorite, lithium chlorite, sodium chlorate, potassium chlorate, lithium chlorate, sodium perchlorate, potassium perchlorate, and lithium perchlorate. In some embodiments, the brine solution has a molarity of about 0.1-0.5 mol/L.

In some embodiments, some or all of the hydrogen gas produced at the cathode in the HER electrolyzer is eventually directed to the gas-diffusion electrode in the HOR fuel cell, where it is oxidized to produce hydrogen ions. In some embodiments, utilizing hydrogen gas at the gas-diffusion electrode from hydrogen generated at the HER cathode, eliminates the need for an external supply of hydrogen; consequently, the utilization of energy by the system is reduced. In some embodiments, the hydrogen may be obtained from the HER cathode and/or may be obtained from an external source, e.g., from a commercial hydrogen gas supplier, e.g., at start-up of the system when the hydrogen supply from the HER cathode is insufficient.

Cation exchange membranes (CEM) are conventionally known in the art and are available from, for example, Asahi Kasei of Tokyo, Japan; or from Membrane International of Glen Rock, N.J., or DuPont, USA. In some embodiments, the polymeric cation-exchange membranes comprise —SO₃⁻, —COO⁻, —PO₃²⁻, —PO₃H⁻, or —C₆H₄O⁻ cation exchange functional groups. The polymers for the preparation of cation-exchange membranes can be perfluorinated ionomers such as NAFION (a perfluorosulfonic-based membrane), FLEMION, and NEOSEPTA-F, partially fluorinated polymers, non-fluorinated hydrocarbon polymers, non-fluorinated polymers with aromatic backbone, or acid-base blends. It will be appreciated that in some embodiments, depending on the need to restrict or allow migration of a specific cation or an anion species between the electrolytes, a cation exchange membrane that is more restrictive and thus allows migration of one species of cations while restricting the migration of another species of cations may be used as, e.g., a cation exchange membrane that allows migration of potassium ions into the cathode electrolyte while restricting migration of other cations into the cathode electrolyte, may be used. Such restrictive cation exchange membranes are commercially available and can be selected by one ordinarily skilled in the art.

Anion exchange membranes (AEM) are conventionally known in the art. In some embodiments, the polymeric anion-exchange membranes comprise —NH₃⁺, —NRH₂⁺, —NR₂H⁺, —NR₃⁺, or —SR₂⁺ anion exchange functional groups. The polymers for the preparation of anion-exchange membranes can be perfluorinated ionomers such as NAFION (a perfluorosulfonic-based membrane), FLEMION, and NEOSEPTA-F, partially fluorinated polymers, non-fluorinated hydrocarbon polymers, non-fluorinated polymers with aromatic backbone, or acid-base blends. It will be appreciated that in some embodiments, depending on the need to restrict or allow migration of a specific cation or an anion species between the electrolytes, an anion exchange membrane that is more restrictive and thus allows migration of one species of anions while restricting the migration of another species of anions may be used as, e.g., an anion exchange membrane that allows migration of chloride ions into the anode electrolyte while restricting migration of other anions into the anode electrolyte, may be used. Such restrictive anion exchange membranes are commercially available and can be selected by one ordinarily skilled in the art.

In some embodiments, the gas diffusion electrode comprises a conductive substrate infused with a catalyst that is capable of catalyzing the oxidation of hydrogen gas to protons. In some embodiments, the GDE comprises a first side that interfaces with hydrogen gas provided to the GDE, and an opposed second side that interfaces with the anolyte. In some embodiments, the portion of the substrate that interfaces with the hydrogen gas is hydrophobic and is relatively dry; and the portion of the substrate that interfaces with the anolyte is hydrophilic and may be wet, which facilitates migration of protons from the GDE to the anolyte. In various embodiments, the substrate is porous to facilitate the movement of gas from the first side to the catalyst that may be located on second side of the GDE. In some embodiments, the catalyst may also be located within the body of the substrate. The substrate may be selected for its porosity to ion migration, e.g., proton migration, from the GDE to the anolyte. In some embodiments, the catalyst may comprise platinum, ruthenium, iridium, rhodium, manganese, silver or alloys thereof. Suitable gas diffusion electrodes are available commercially, e.g., from E-TEK (USA) and other suppliers.

In some embodiments, a cathode comprises an electrocatalyst selected from platinum, a single-crystal nickel, Raney nickel, platinized nickel, a metal carbide (W_{2C}, Pt—W_{2C}), a platinum group metal alloy (Pt-M, where M=Fe, Mn, Cr, Co, Au), a transition metal, a nickel alloy, sintered nickel, a platinum group metals (Pt, Pd, Ru, Rh), gold, silver, a precious or non-precious chalcogenides, a discrete macrocyclic complex of transition metals, and biological complexes.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The present subject matter described herein may be a system, a method, and/or a computer program product. In some embodiments, the computer program product may include a computer readable storage medium (or media) having computer readable program instructions thereon for causing a processor to carry out aspects of the present subject matter.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The specific examples that follow are only intended for the purposes of illustration, and are not to be construed as limiting in any manner to make compounds of the disclosure by other methods.

### Example 1

Effect of Different Ion-Exchange Membranes on the Electrochemical System A variety of ion exchange membranes, as well as their combinations, can meet the electrochemical reaction needs of the system. As shown in FIG. 1, both membrane reactors (FIG. 1a) and (FIG. 1c) can use a cation exchange membrane or a proton exchange membrane to separate the reaction medium between two electrodes. In this condition, the cation (or proton) will transfer from anode chamber to cathode chamber. Also, both membrane reactors (FIG. 1a) and (FIG. 1c) can use an anion exchange membrane or a hydroxyl exchange membrane to separate the reaction medium between two electrodes while the anion (or hydroxyl) will transfer from cathode chamber to anode chamber. Similarly, reactors (FIG. 1a) and (FIG. 1c) also can use different ion exchange membranes or combinations of multiple exchange membranes to improve the performance of the single reactor.

### Example 2

### Effect of Absorbent Concentration on CO₂ Capture Capability in the System

Absorbent concentration is an important factor that affects absorption process efficiency of CO₂ in the absorption unit. High-concentration caustic soda solution will greatly improve the absorption efficiency and obtain a solution with high total carbon dioxide absorption. Caustic soda solution with a concentration of 0.01 mol/L to 15 mol/L can effectively absorb CO₂.

### Example 3

### Energy Consumption and Efficiency Calculations

In a system using 1 mol/L caustic soda as an absorbent, each ton of CO₂ captured from the air will consume 505 kWh of electricity, including 1333 kWh of electricity consumed by the chlor-alkali electrolysis cell and −828 kWh of electricity compensated by hydrogen-chlorine fuel cells. This power utilization efficiency far exceeds the existing thermochemical process-based capture system.

### Example 4

### Representative CO₂ Capture System

A representative example of a presently disclosed CO₂ capture system is provided in FIG. 1. Referring now to FIG. 1, brine is first electrolyzed by electricity-driven membrane reactor (a), chlorine gas and electrolyte containing chlorine gas are produced in the anode chamber, and hydrogen gas and caustic soda are produced in the cathode chamber. After the hydrogen and caustic soda are separated by the gas-liquid separator (b), the caustic soda solution is injected into the carbon dioxide absorption device (d) and reacts with the CO₂ source to generate sodium carbonate or sodium bicarbonate solution. At the same time, chlorine gas and the electrolyte solution containing chlorine gas and hydrogen react in the membrane reactor (c), and the electrical energy output partially compensates the energy of the membrane reactor (a) electrolysis, and the hydrochloric acid solution generated at the same time neutralizes the reaction in acid and alkali reactor (e) reacts with sodium carbonate or sodium bicarbonate produced after absorption, and CO₂ is released as pure gas.

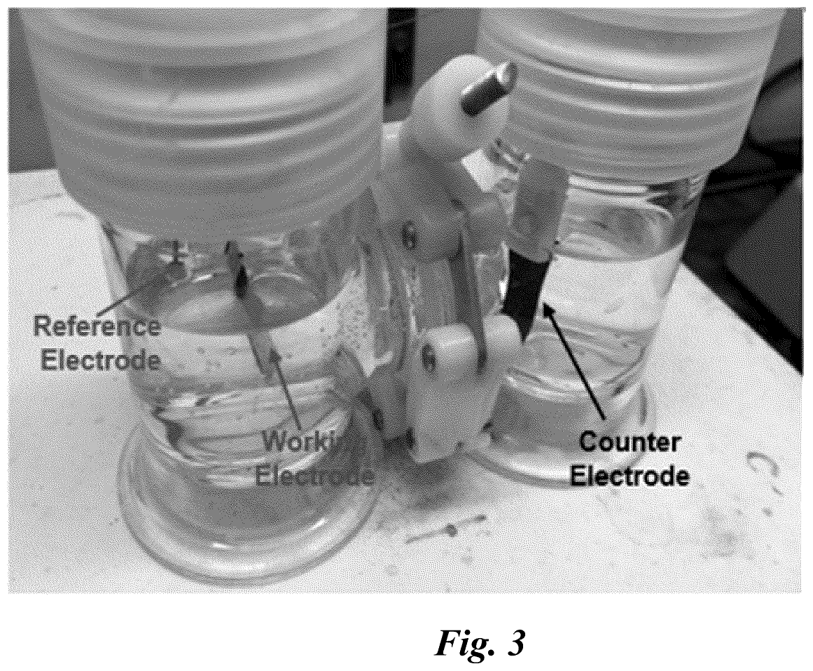

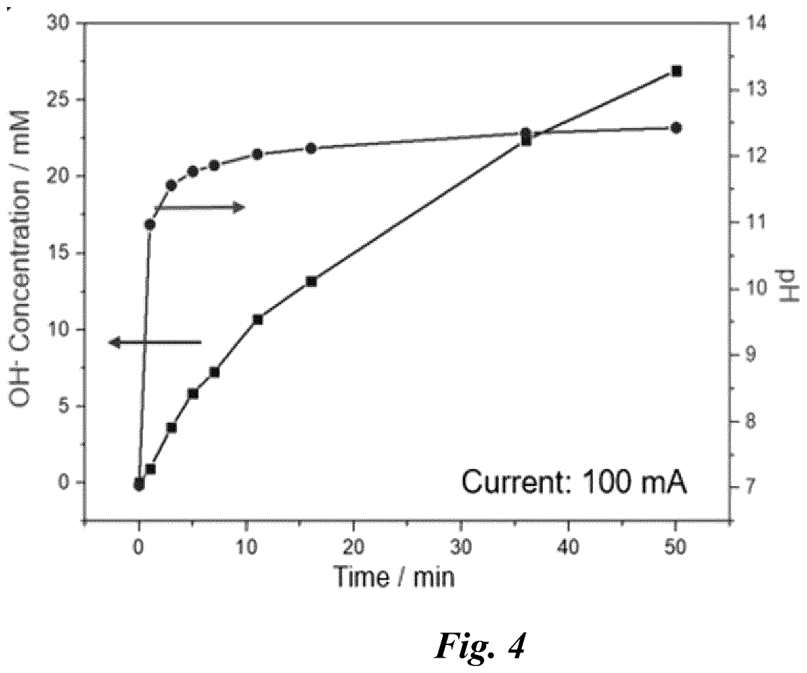

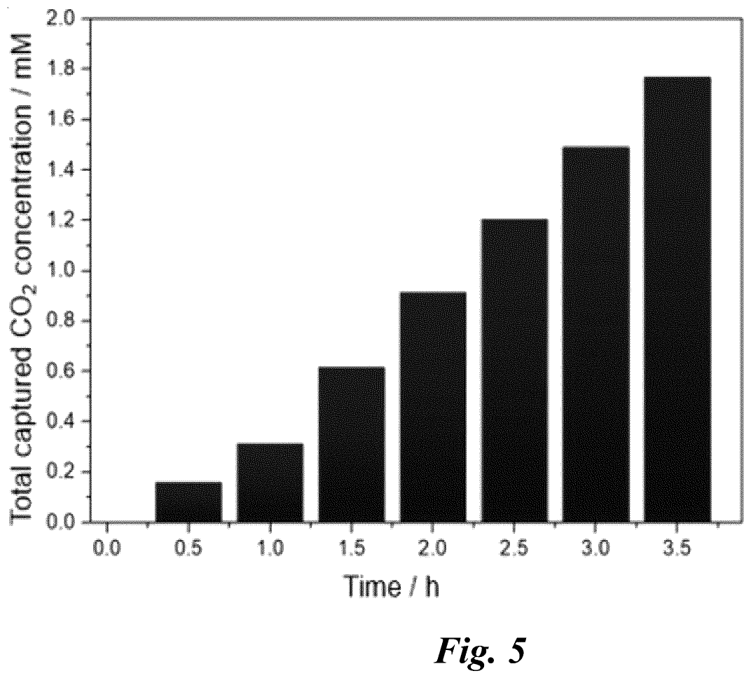

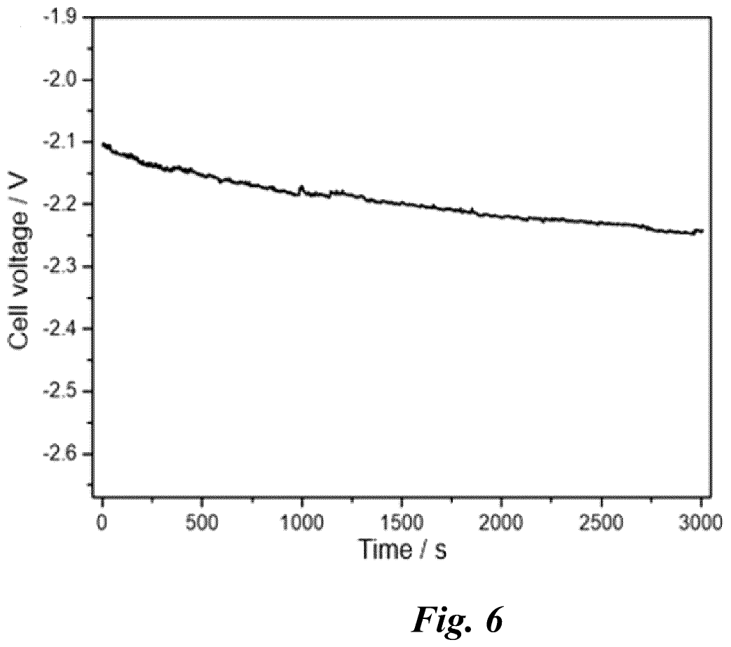

Referring now to FIG. 3, in a representative embodiment, a three-electrode cell was assembled with Nafion™, e.g., a sulfonated tetrafluoroethylene based fluoropolymer-copolymer, as the cation exchange membrane. Commercial 20% Pt/C and RuO₂ powder were used as the cathode and anode electrocatalysts, respectively. A NaCl solution of 26% was used as the electrolyte. At a cell voltage of approximately 2.1 V to 2.2 V, a modest current of 100 mA was delivered with an electrode area of approximately 1 cm² (FIG. 6). As the electrolysis proceeds, the pH of the catholyte increases, achieving approximately a pH of 12.5 within 50 min of operation, which corresponds to a hydroxide concentration of 28.2 mM (FIG. 4). This basic solution was then used to capture CO₂ from air. CO₂ (400 ppm) present in the air reacts with sodium hydroxide in the solution to form NaHCO₃/Na₂CO₃, the concentrations of which were determined by using acid titration. The amount of captured CO₂ was found to increase with time, reaching 1.8 mM within 3.5 hours (FIG. 5).

According to the acid-base reaction equilibria of CO₂/HCO₃⁻/CO₃²⁻, the maximal concentration of carbon (HCO₃⁻+CO₃²⁻) can reach approximately 1.8 M (hits the limit of Na₂CO₃ solubility limit). It is noted that the maximum microalgae growth rate can be as high as 0.88 day⁻¹ by using 29.7 mM NaHCO₃. This value could be readily achieved with longer-time and more efficient air-liquid contact (e.g., using an CO₂ absorption reactor shown in FIG. 1d).

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents form part of the common general knowledge in the art.
Fasihi, M., Efimova, O., and Breyer, C. (2019). Techno-economic assessment of CO₂ direct air capture plants. Journal of Cleaner Production, 224, 957-980.
Keith, D. W., Holmes, G., Angelo, D. S., and Heidel, K. (2018). A process for capturing CO₂ from the atmosphere. Joule, 2(8), 1573-1594.
Hanusch, J. M., Kerschgens, I. P., Huber, F., Neuburger, M., and Gademann, K. (2019). Pyrrolizidines for direct air capture and CO₂ conversion. Chemical Communications, 55(7), 949-952.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A system for capturing CO₂ comprising:
(a) a first membrane reactor comprising an ion-exchange membrane operationally positioned between an anode chamber and a cathode chamber, wherein the anode chamber comprises an inlet in fluid communication with a brine source and an outlet for Cl₂/H₂O and wherein the cathode chamber has a water inlet and an outlet for H₂ and caustic soda;
(b) a gas-liquid separator comprising an inlet in fluid communication with the outlet for H₂ and caustic soda of the cathode chamber of the first membrane reactor and a first outlet for H₂ and a second outlet for NaOH;
(c) a CO₂ absorption reactor, wherein the CO₂ absorption reactor has an inlet for introducing CO₂ from a CO₂ source, an inlet for caustic soda in fluid communication with the gas liquid separator, and an outlet for NaHCO₃/Na₂CO₃;
(d) a second membrane reactor comprising an ion-exchange membrane operationally positioned between an anode chamber and a cathode chamber, wherein the anode chamber has an inlet for Cl₂ in fluid communication the outlet of the anode chamber of the first membrane reactor and an outlet for HCl and wherein the cathode chamber has an inlet in fluid communication with the H₂ outlet of the gas-liquid separator and an aqueous NaOH solution outlet; and
(e) an acid-base reactor comprising a first inlet in fluid communication with the HCl outlet of the anode chamber of the second membrane reactor and a second inlet in fluid communication with the NaHCO₃/Na₂CO₃ outlet of the CO₂ absorption reactor and a first outlet in fluid communication with the brine source and a second outlet for releasing CO₂;
wherein the second membrane reactor is configured to produce an electricity output and is in electrical communication with the first membrane reactor.

2. The system of claim 1, wherein the ion exchange membrane of the first membrane reactor and/or the ion exchange membrane of the second membrane reactor comprises a cation exchange membrane or a proton exchange membrane.

3. The system of claim 1, wherein the ion exchange membrane of the first membrane reactor and/or the ion exchange membrane of the second membrane reactor comprises an anion exchange membrane or a hydroxyl exchange membrane.

4. The system of claim 1, wherein the CO₂ absorption reactor further comprises a water trap.

5. A method for capturing CO₂ from a CO₂ source comprising:
(a) providing the system of claim 1;
(b) introducing brine into the anode chamber of the first membrane reactor, thereby electrolyzing the brine and producing chlorine gas and electrolyte-containing chlorine gas in the anode chamber and hydrogen gas and caustic soda in the cathode chamber;
(c) separating the hydrogen gas and caustic soda with the gas-liquid separator;
(d) injecting the caustic soda and carbon dioxide (CO₂) from a CO₂ source into the CO₂ absorption reactor to generate sodium carbonate or sodium bicarbonate;
(e) disposing the sodium carbonate or sodium bicarbonate in the acid-base reactor;
(f) reacting the chlorine gas and the electrolyte-containing chlorine gas with hydrogen in the second membrane reactor to produce hydrochloric acid and an electrical output;
(g) reacting the hydrochloric acid with sodium carbonate or sodium bicarbonate in acid and alkali reactor to produce CO₂; and
(ix) releasing the CO₂.

6. The method of claim 5, further comprising transmitting an electricity output of the second membrane reactor to the first membrane reactor or to an external electricity grid.

7. A eDAC system for capturing CO₂ comprising:
(a) hydrogen evolution reaction (HER) electrolyzer comprising an electrolyzer anode, an electrolyzer cathode, a first chamber, and a second chamber, wherein the first chamber comprises a redox mediate solution, wherein the redox mediate solution is contacting the electrolyzer anode, and the second chamber comprises a catholyte, wherein the catholyte is contacting the electrolyzer cathode, wherein the first chamber comprises an M^{x+} inlet and an M^{(x+1)} outlet, and (ii) the second chamber comprises a water inlet and an outlet for H₂ and caustic soda;
(b) electrolyte storage tanks, wherein a first electrolyte storage tank comprises (i) an inlet in fluid communication with the M^{(x+1)} outlet of the first chamber and (ii) an M^{(x+1)} outlet;
(c) a gas-liquid separator comprising (i) an inlet in fluid communication with the H₂ and caustic soda outlet of the second chamber, (ii) an H₂ outlet, and (iii) a NaOH outlet;
(d) a hydrogen storage tank comprising (i) an inlet in fluid communication with the H₂ outlet of the gas-liquid separator and (ii) an H₂ outlet;
(e) a hydrogen oxidation reaction (HOR) fuel cell comprising a gas-diffusion electrode, a fuel cell cathode, a third chamber and a fourth chamber, wherein the third chamber comprises an anolyte contacting the gas diffusion electrode (GDE), and wherein the fourth chamber comprises the redox mediate solution, wherein the redox mediate solution is contacting the fuel cell cathode, wherein the GDE is in fluid communication with the H₂ outlet of the hydrogen storage tank and wherein the fourth chamber comprises (i) an inlet in fluid communication with the M^{(x+1)} output of the first electrolyte storage tank and (ii) an M^{x+} outlet and an aqueous HCl solution outlet;
(f) a gas-liquid contactor comprising (i) a first inlet for CO₂, (ii) a second inlet in fluid communication with the NaOH outlet of the gas-liquid separator, and (iii) a NaHCO₃/Na₂CO₃ outlet; and
(g) an acid-base reactor comprising (i) a first inlet in fluid communication with the NaHCO₃/Na₂CO₃ outlet of the gas-liquid contactor, (ii) a second inlet in fluid communication an aqueous HCl outlet of the HOR fuel cell; and (iii) a pure CO₂ outlet;
wherein M is a metal selected from the group consisting of Fe, V, Cr, and Mn; and
x is an integer selected from 2, 3, and 4.

8. The eDAC system of claim 7, wherein the system further comprises a fifth chamber for a brine solution, wherein the fifth chamber comprises an anion exchange membrane (AEM) and a cation exchange membrane (CEM), wherein the fifth chamber is positioned (i) between the first and second chambers in the HER electrolyzer such that the AEM is contacting the redox mediate solution and the CEM is contacting the catholyte, or (ii) between the third and fourth chamber in the HOR fuel cell such that the AEM is contacting the anolyte and the CEM is contacting the redox mediate solution.

9. The eDAC system of claim 7, wherein a second electrolyte storage tank comprises (i) an inlet in fluid communication with the M^{x+1} outlet of the fourth chamber and (ii) an M^{x+} inlet in the first chamber.

10. The eDAC system of claim 7, wherein the fifth chamber is positioned between the first and second chambers in the HER electrolyzer and wherein the HOR fuel cell further comprises an AEM positioned between the third and fourth chambers such that the AEM is contacting the anolyte and the redox mediate solution.

11. The eDAC system of claim 10, further comprising a sixth chamber comprising hydrogen gas contacting the GDE.

12. The eDAC system of claim 10, further comprising directly introducing the hydrogen gas to the GDE.

13. The eDAC system of claim 7, wherein the fifth chamber is positioned between the third and fourth chambers in the fuel cell unit and wherein the electrolyzer unit further comprises a CEM between the first and second chambers such that the CEM is contacting the redox mediate solution and the catholyte.

14. The eDAC system of claim 7, further comprising a module for receiving an electricity output from the HOR fuel cell and providing the electricity output to the HER electrolyzer.

15. The eDAC system of claim 7, wherein M is Fe or V.

16. A method for capturing carbon dioxide from a carbon dioxide source, the method comprising:
(a) providing a eDAC system of claim 7;
(b) oxidizing M^{x+} to M^{(x+1)} in the first chamber and storing the M^{(x+1)} in the first electrolyte storage tank;
(c) producing H₂ and caustic soda in the second chamber;
(d) separating the H₂ and caustic soda in the gas-liquid separator;
(e) storing the H₂ in the hydrogen storage tank;
(f) contacting the caustic soda with carbon dioxide (CO₂) from a CO₂ source in the CO₂ absorption reactor to generate sodium carbonate or sodium bicarbonate;
(h) introducing the M^{(x+1)} and H₂ into the HOR fuel cell to form M^{x+} and hydrochloric acid;
(i) injecting the hydrochloric acid and sodium carbonate or sodium bicarbonate into the acid-base reactor to form CO₂; and
(j) releasing the CO₂.

17. (canceled)

18. The method of claim 5, wherein the carbon dioxide source comprises a dilute source of carbon dioxide.

19. The method of claim 18, wherein the dilute source comprises ambient air.

20. The method of claim 5, wherein the carbon dioxide source comprises a concentrated source of carbon dioxide.

21. The method of claim 20, wherein the concentrated source of carbon dioxide comprises a point source of carbon dioxide.

22.-24. (canceled)
